(19) United States
(12) Patent Application Publication
(10) Pub. No.: US 2014/0165454 A1
(43) Pub. Date: Jun. 19, 2014

(54) FLEXIBLE ELECTRIC FLYSWATTER WITH SHAPE MEMORY CAPABILITIES

(71) Applicant: Nathan Louis Gordon, IV, Temple City, CA (US)

(72) Inventor: Nathan Louis Gordon, IV, Temple City, CA (US)

(21) Appl. No.: 14/091,333

(22) Filed: Nov. 26, 2013

Related U.S. Application Data
(60) Provisional application No. 61/797,103, filed on Nov. 29, 2012.

(51) Int. Cl. A01M 3/02

(52) U.S. Cl. CPC A01M 3/025
USPC 43/137

(57) ABSTRACT

A flexible electric fly swatter comprising a grid of electrically conducting shape memory materials encased within a flexible frame for striking against and electrocuting a fly on a surface or in the air. The single layer grid has odd and even rods oppositely charged where both the frame and the grid return back to their original shape after being struck. An alternate embodiment of this invention is a flexible electric fly swatter comprising two or more meshes in parallel of electrically conducting shape memory materials that are fastened together with connecting-spacers to allow a gap between the top mesh and the bottom meshes such that when a fly touches the meshes the circuit is completed and the fly is electrocuted. Also included in this invention is a spring-pivot-hinge fastened between the dorsal part of the handle to the proximal part of the frame or meshes.

### CROSS-REFERENCE TO RELATED APPLICATIONS

This application claims the benefits of provisional patent application Ser. No. 61/797,103 filed 2012 Nov. 29 by the present inventor.

### BACKGROUND

### Prior Art

The following is a tabulation of some prior art that presently appears relevant:

| | | | |
|---|---|---|---|
| 7,739,830 | June 2010 | Wells | 43/137; 43/132.1 |
| 7,540,112 | June 2009 | Crenshaw | 43/137; D22/124 |
| 6,055,767 | May 2000 | Carter | 43/134, 136, 137 |
| 5,531,436 | October 1994 | Merrick | 43/137; 132.1; 112 |
| 5,269,092 | December 1993 | Cobble | 43/134, 135, 136, 137 |
| 4,910,909 | March 1990 | Johnson | 43/137 |
| 4,905,408 | March 1990 | Wu | 43/136, 137 |
| 4,617,754 | October 1986 | Miley | 43/137 |
| 3,905,146 | September 1975 | Ralston | 43/137; D22/20; D88/2 |
| 3,673,730 | July 1972 | Hcgenberger | 43/137 |
| 2,934,851 | May 1960 | Grish | 43/137 |
| 2,881,554 | October 1958 | Laine | 43/137 |
| 1,879,495 | November 1932 | Renwick | |
| 1,179,303 | April 1916 | Hanlon | |

### NON-PATENT LITERATURE DOCUMENTS

Fly-killing device, wikipedia.org (Nov. 20, 2013 11:35 PM), http://en.wikipedia.org/wild/Flyswatter

Dynazap extendable insect zapper, dynatrap.com (Nov. 20, 2013 11:35 PM), http://dynatrap.com/dynazap/index.html

Winner, Winner, WINesday #5: Dynazap® Extendable Insect Racket Zapper Review+Giveaway!, shesaved.com (Nov. 20, 2013 11:35 PM), http://www.shesaved.com/2012/08/winner-winner-winesday-5-dynazap-extendable-insect-racket-zapper-review-giveaway.html

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention is directed toward electric flyswatters.

### BACKGROUND OF THE INVENTION

What was invented is a flexible electric flyswatter with shape memory capabilities. This invention relates generally to electric fly swatters. It is generally well known that flies within a building often land on flat surfaces, such as a wall or table, where they cannot be swatted by a traditional electric fly swatter due to their ridged outer frame and ridged grid assembly. To date, traditional electric flyswatters still follow the 1932 Renwick invention described in issued U.S. Pat. No. 1,879,495 along with the 1959 Laine invention described in issued U.S. Pat. No. 2,881,554. Both the Renwick and Laine electric flyswatters contain a ridged outer frame an exoskeleton to containing wire grids. These traditional electric flyswatters are ridged and the outer frame housing the wire grids will crack upon being struck on a hard, non-brittle surface. Furthermore, the wire grids or alternately the meshes which are a component of these flyswatters will permanently bend out of shape upon being struck on a hard, non-brittle surface. Normally, a person using an electric fly swatter either strikes the fly while in midnight while the fly is in the air or by gently placing the face of the electric fly swatter directly over the fly while it rests on a surface and then waiting until the fly travels into the grids where the fly is subsequently electrocuted. This limitation can be best illustrated by the Dynazap™ brand electric flyswatter which incorporates the Laine invention along with the Little invention; where the Little invention is described in issued U.S. Pat. No. 4,120,114. The Dynazap™ invention incorporates a preset extendable handle along with a preset swivel in its invention. It must be noted that the Renwick, Laine and Dynazap™ inventions cannot be used to strike a fly on a hard surface without causing significant damage to the electric flyswatter due to its ridged frame. It should be further noted that the Dynazap™ handle swivel arrangement must be preset and that the handle swivel on the Dynazap™ does not spring back, but rather it must be preset in a fixed place by the user before each use. Each of these inventions has limitations which have prevented them from becoming widely used.

Accordingly, it is a principal object of this invention to provide an electric fly swatter that is flexible enough in nature to strike a fly on a bard non-brittle surface.

### BRIEF SUMMARY OF THE INVENTION

The disclosure herein is an electric flyswatter for electrocuting a fly resting on a surface or while the fly is in flight. The term “fly” is taken to mean any flying or crawling insect, including: flies, mosquitoes, wasps, bees, ants, and spiders that are common pests. The electric flyswatter of this invention is formed of non-electrically conducting shape memory material for the frame and electrically conducting shape memory material for the rods contained within the frame.

A unique feature of this electric flyswatter is that the frame is flexible and will allow for striking on a surface without cracking or breaking. The flexibility of the frame is accomplished by utilizing shape memory polymers where there is a grooved track within the frame to encase the rods. The oppositely charged rods within the frame are comprised of electrically conducting shape memory metals which allows the rods to return back to their original shape after being deformed when striking a surface. This synergism of utilizing electrically conducting shape memory materials and non-electrically conducting shape memory materials in a flyswatter allows for the flexibility found in a traditional flyswatter combined with the benefits of electricity for killing a fly on a surface or while in the air.

Another unique feature of an alternate embodiment of this electric flyswatter is that the flexible frame is connected to the handle by a spring swivel. The spring swivel is employed to allow the frame to bend relative to the handle and to automatically return back straight relative to the handle.

An alternate embodiment of this flexible electric flyswatter invention is that two or more electrically conducting meshes of shape memory alloy are held in parallel and fastened together with non-electrically conducting connecting-spacers to allow a gap between the top mesh and the bottom meshes such that when a fly touches the top and bottom meshes the circuit will complete and the fly is subsequently electrocuted. Also included in the second embodiment is a spring-pivot-hinge fastened between the dorsal part of the handle to the proximal end of the plurality of parallel meshes. The spring swivel is employed to allow the meshes to bend relative to the handle and return back straight relative to the handle.

The electric flyswatter is constructed so that after striking a fly on a surface the rods, frame and handle will return back to their original position; or alternately, the electric flyswatter is constructed so that after striking a fly on a surface the meshes and handle will return back to their original position. The flexible electric fly swatter is constructed so that a fly is killed by electrocution and not by squashing or compressing.

Further objects and features of the present invention will be apparent, to those skilled in the art upon reference to the accompanying drawings and upon reading the following description of the preferred embodiments.

A better understanding of the invention will come from the following description and claims taking in conjunction with the attached drawings.

### BRIEF DESCRIPTION OF THE DRAWINGS

FIG. 1 is a perspective view of a flexible electric flyswatter showing the frame in a bent position;

FIG. 2 is a perspective view of a flexible electric flyswatter with frame and handle shown in a straight position;

FIG. 3 is a flowchart showing the grounding element that is incorporated into the basic components of an electric flyswatter;

FIG. 4 is a partially exploded perspective view of the inner portion of the flexible frame;

FIG. 5 is a perspective view of an alternate embodiment wherein a handle is connected to a frame by a spring-pivot-hinge showing handle bent relative to the frame;

FIG. 6 is a perspective view of an alternate embodiment wherein a handle is connected to a frame by a spring-pivot-hinge showing both handle and frame in a straight position;

FIG. 7 is a perspective view of an alternate embodiment wherein a handle is connected to a frame by a spring-pivot-hinge where the handle is bent relative to the frame after a proximal strike;

FIG. 8 is a perspective view of an alternate embodiment wherein a handle is connected to a frame by a spring-pivot-hinge where the handle is bent relative to the frame after a distal strike;

FIG. 9 is a partial perspective view of an alternate embodiment of a flexible electric flyswatter showing two meshes in parallel having been deformed after striking a hard surface;

FIG. 10 is a partial perspective view of an alternate embodiment of a flexible electric flyswatter showing a plurality of electrically conducting parallel meshes connected to a handle by means of a spring-pivot-hinge in a straight position;

FIG. 11 is a partial perspective view of an alternate embodiment of a flexible electric flyswatter showing a plurality of electrically conducting parallel meshes connected to a handle by means of a spring-pivot-hinge in a straight position;

FIG. 12 is a partially exploded view of an alternate embodiment of a flexible electric flyswatter with two electrically conducting meshes that are fastened together with connecting-spacers that creates a gap space in-between the fastened parallel top and bottom mesh where the parallel fastened mesh assembly is further connected to a handle by means of a spring-pivot-hinge;

FIG. 13 is a perspective view of an alternate embodiment wherein a handle is connected to the parallel meshes by a spring pivot hinge, showing handle bent relative to the parallel meshes;

FIG. 14 is an isometric view of a non-deformed mesh from the alternate embodiment;

FIG. 15 is an isometric view of a connecting-spacer from the alternate embodiment;

FIG. 16 contains perspective views of a spring-pivot-hinge flexed both dorsally and proximately.

### DRAWINGS—REFERENCE NUMERALS

11 flexible electric flyswatter

11′ flexible electric flyswatter with swivel-pivot-hinge

111 alternate embodiment flexible electric flyswatter

12 a single layer grid

13 rods

14 flexible frame

15 handle

16 fly

17 grounding element

18 power source

19 combination inverter and voltage multiplier

20 grove track

21 spring-pivot-hinge

22 end-caps

23 top mesh

24 bottom mesh

25 connecting-spacers

26 cut away section

27 cut away section

### DETAILED DESCRIPTION OF THE PREFERRED EMBODIMENTS

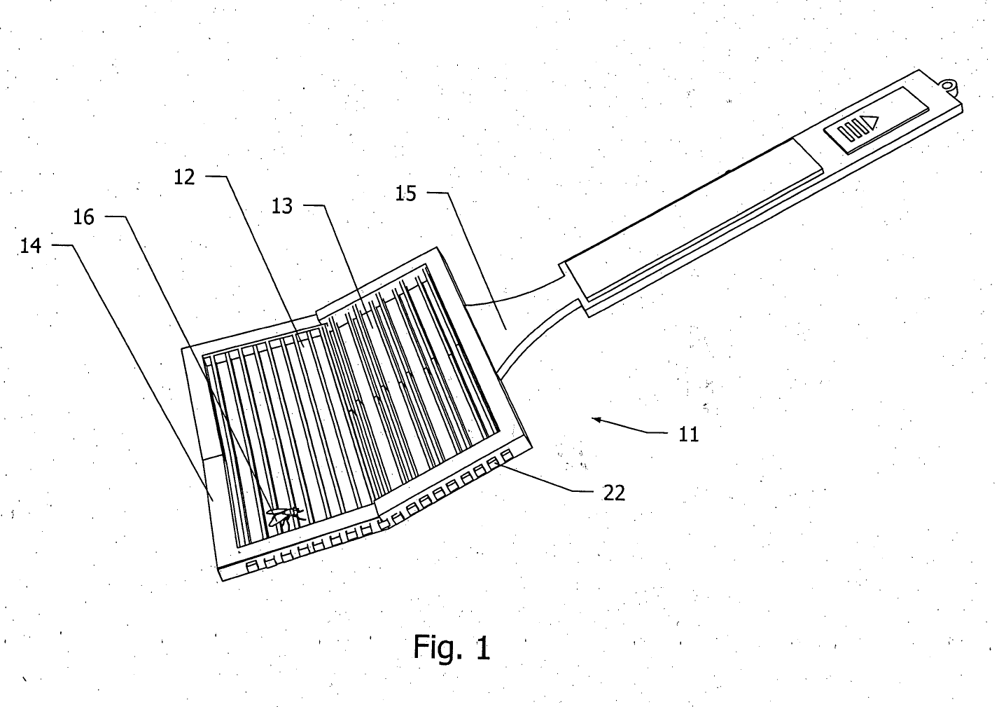

Referring to the drawings, and first to FIG. 1 an embodiment of the flexible electric flyswatter of this invention is identified with the numeral 11. The flexible electric flyswatter contains three basic portions,—that is, a single layer grid 12 (where the grid 12 comprises oppositely charged rods 13 of shape memory material), the grid 12 is encased within a flexible frame 14, where the flexible frame 14 is connected to a handle 15. At the distal and proximal ends of rod 13 are end-caps 22 to prevent a rod from escaping from the flexible frame 14. The flexible electric flyswatter 11 is shown in a deformed position which occurs upon the impact of striking and electrocuting a fly 16 on a hard surface.

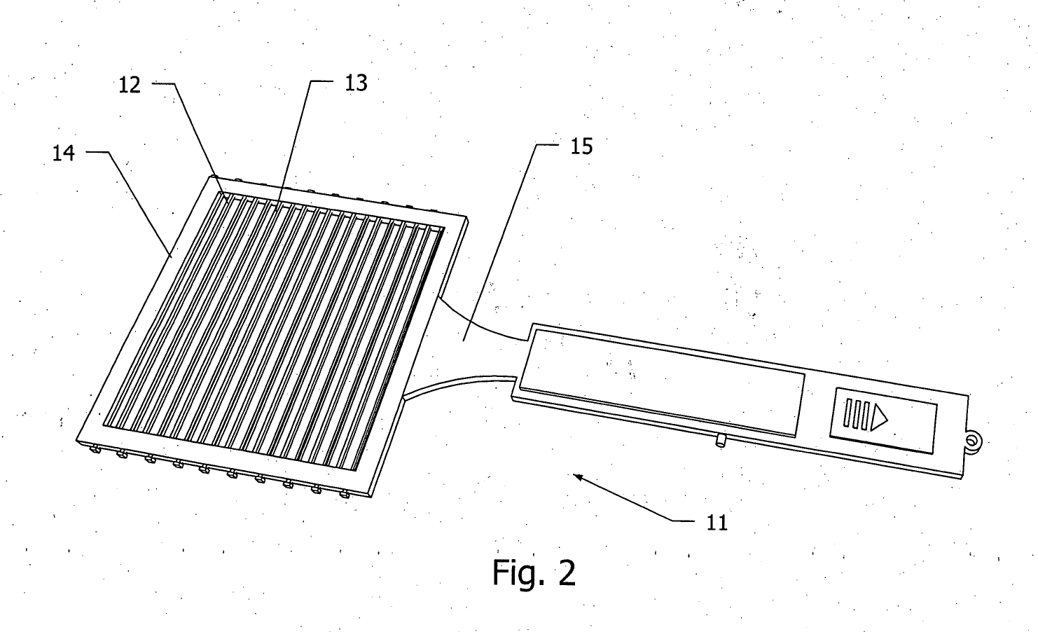

FIG. 2 is a perspective view of a flexible electric flyswatter 11 where a single layer grid 12 comprising oppositely charged rods 13 of shape memory material are encased within a flexible frame 14 and attached to handle 15 and the flexible electric flyswatter 11 is shown in a straight position.

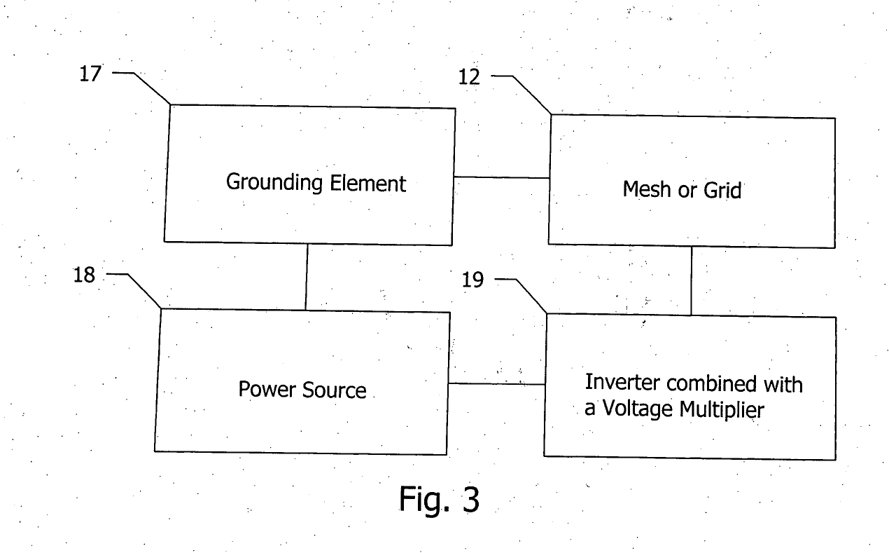

FIG. 3 is a flowchart showing; a grounding element 17 that is incorporated into the standard electric fly swatter circuitry comprising a grid 12, a power source 18, and combination inverter and voltage multiplier 19.

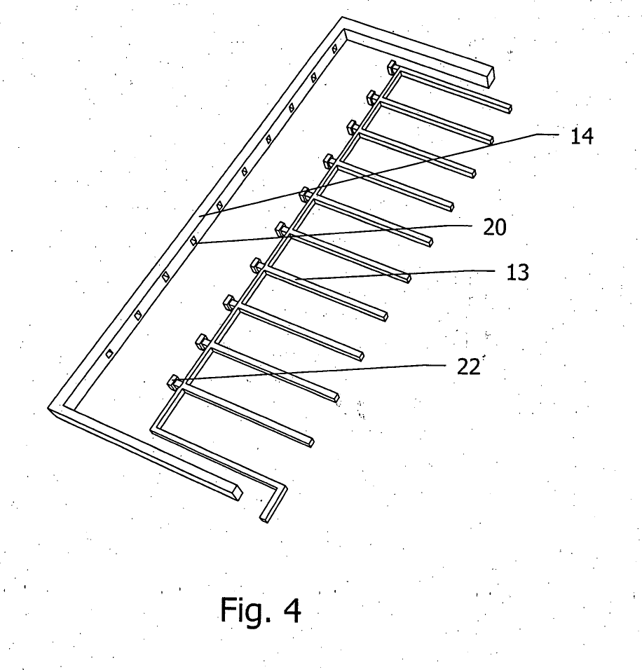

FIG. 4 is a partially exploded perspective view of the inner portion of a flexible frame 14 showing a grove track 20 in which a single rod 13 is encased. Grove track 20 facilitates rod 13 when rod 13 slides upon being struck on a surface. At the proximal end of rod 13 arc end-caps 22 to prevent a rod from escaping from the flexible frame 14.

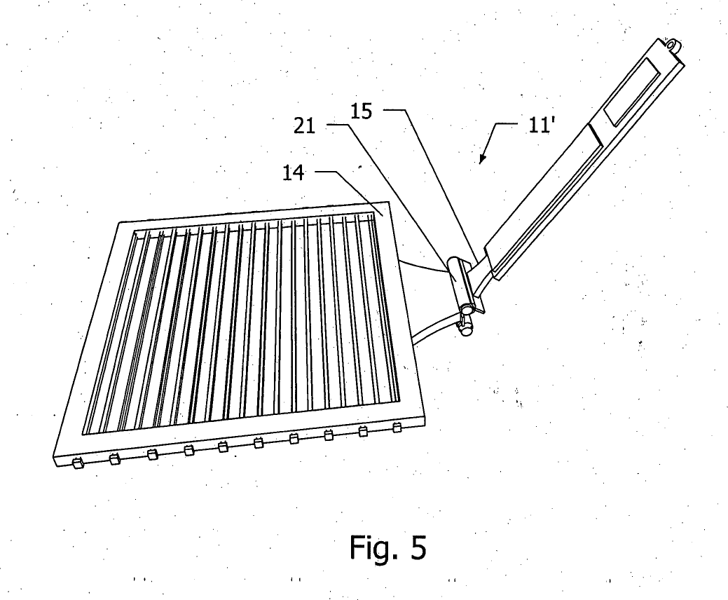

FIG. 5 is a perspective view of an alternate embodiment of this invention 11′ wherein a handle 15 is connected to a frame 14 by a spring-pivot-hinge 21 to allow the frame to bend relative to the handle and return back straight relative to the handle.

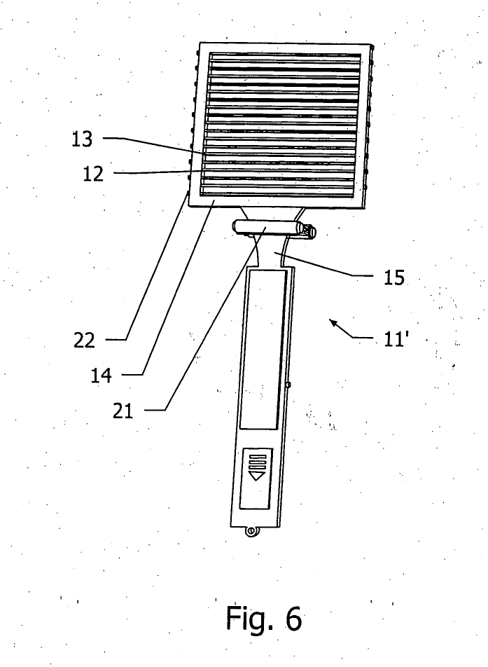

FIG. 6 is a perspective view of an alternate embodiment of this invention 11′wherein a handle 15 is connected to the frame 14 by a spring-pivot-hinge 21 and shown in a straight position. The alternate embodiment 11′ contains four basic portions,—that is, a single layer grid 12 (where grid 12 comprises oppositely charged rods 13 of shape memory material), the grid 12 is encased within a flexible frame 14, where the flexible frame 14 is connected to a handle 15 by a spring-pivot-hinge 21. Also shown at the distal and proximal ;ends of rod 13 are end-caps 22 to prevent a rod from escaping from the flexible frame 14.

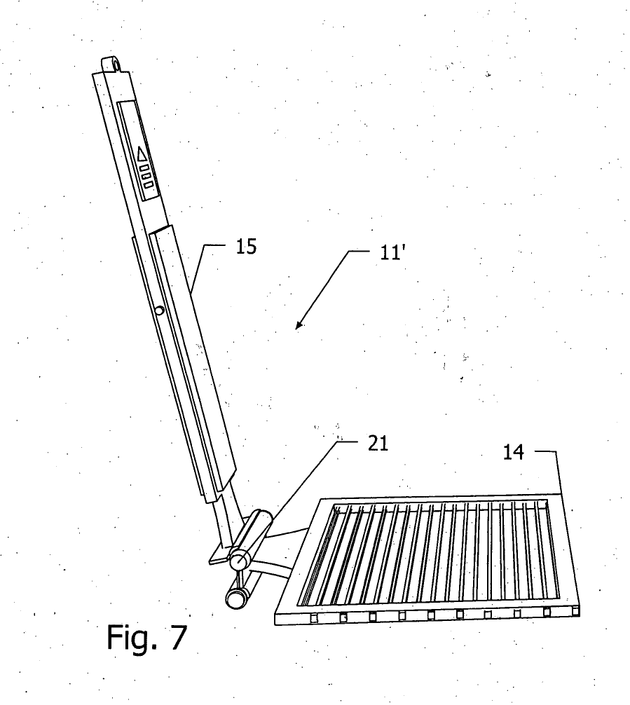

FIG. 7 is a perspective view of an alternate embodiment of this, invention 11′ wherein a handle 15 is connected to a frame 14 by a spring-pivot-hinge 21 where the handle 15 is bent relative to the frame 14 after a proximal strike.

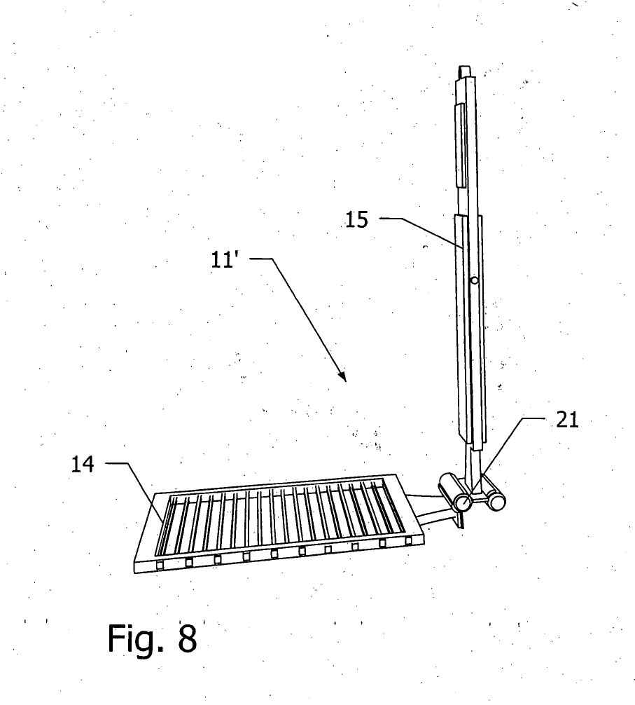

FIG. 8 is a perspective view of an alternate embodiment of this invention 11′ wherein a handle 15 is connected to a frame 14 by a spring-pivot-hinge 21 where the handle 15 is bent relative to the frame 14 after a distal strike.

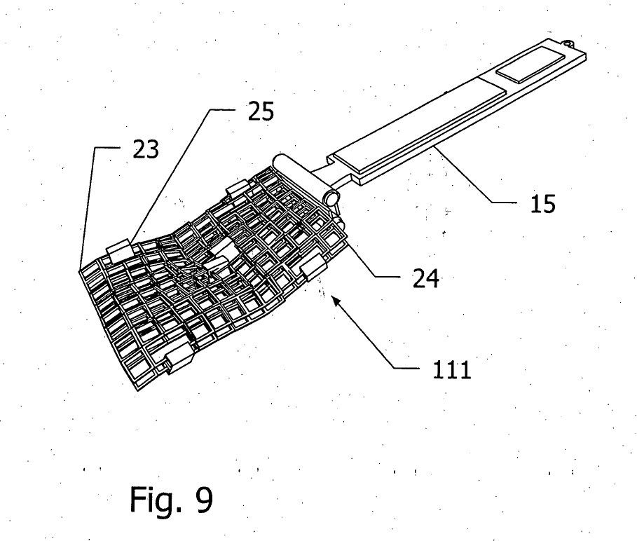

FIG. 9 is an alternate embodiment of the flexible electric flyswatter of this invention is identified with the numeral 111. This embodiment of the flexible electric flyswatter contains three basic portions,—that is: First, two or more electrically conducting meshes that are fastened so that the planes of the meshes are parallel with respect to each other and not in direct contact. The planes of the top mesh 23 and bottom mesh 24 (where the meshes 23 and 24 respectively are comprised of shape memory alloy), are fastened together in parallel although a gap is formed between the planes of the meshes by a plurality of connecting-spacers 25. Second, the connecting-spacers 25 which make up the second portion of this embodiment are comprised of non-electrically conducting shape memory material. Third, the plurality of spaced apart parallel meshes are connected to a handle 15. The meshes (mesh 23 and mesh 24 respectively) of this flexible electric flyswatter 111 are shown in a deformed position which occurs upon the impact of striking and electrocuting a fly on a hard surface.

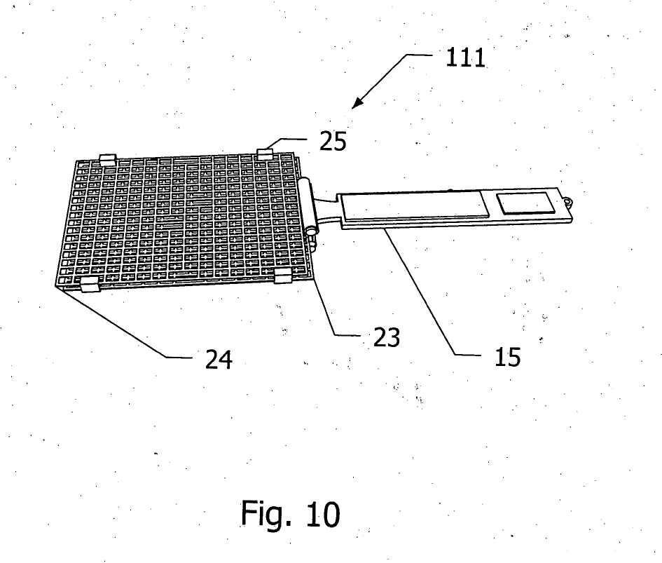

FIG. 10 is a partial perspective view of an alternate embodiment flexible electric flyswatter 111 where a top mesh 23 and bottom mesh 24 are comprised of electrically conducting shape memory material. The directional planes of the top and bottom meshes are separated with a gap in-between and fastened in a parallel arrangement by connecting-spacers 25. Finally the parallel meshes are connected to a handle 15 and this arrangement is depicted in FIG. 10 as a front view in a straight position.

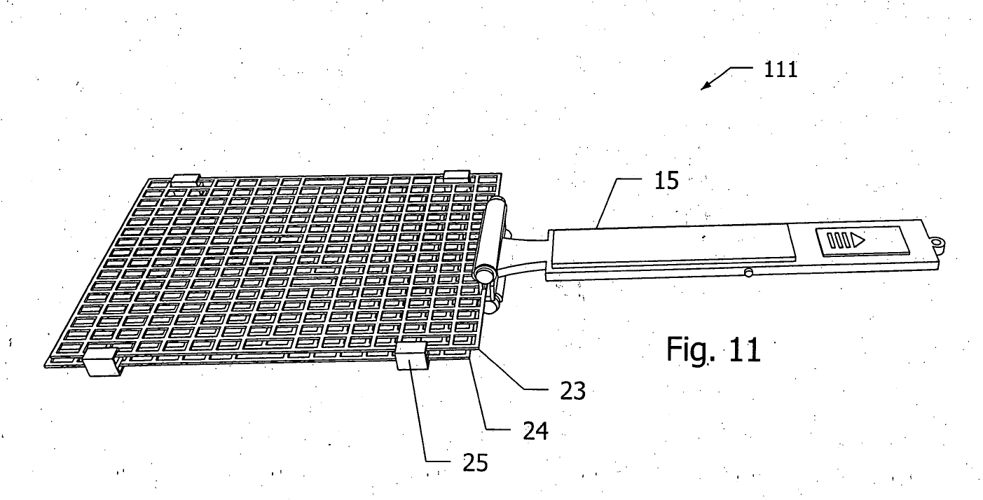

FIG. 11 shows a partial perspective view of an alternate embodiment flexible electric flyswatter 111 where a top mesh 23 and bottom mesh 24 are comprised of electrically conducting shape memory material. The directional planes of the top and bottom meshes are separated with a gap in-between and fastened in a parallel arrangement by connecting-spacers 25. Finally the parallel meshes are connected to a handle 15 and this arrangement is depicted in FIG. 10 as a side view in a straight position.

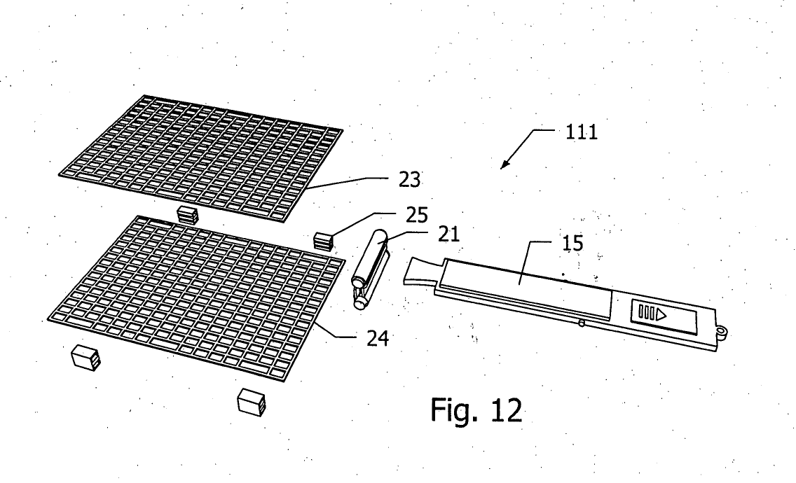

FIG. 12 is a partially exploded view of an alternate embodiment of a flexible electric flyswatter 111 where two electrically conducting meshes (top mesh 23 and bottom mesh 24 respectively) are fastened together with connecting-spacers 25 where the parallel fastened mesh assembly is further connected to handle 15 by means of spring-pivot-hinge 21.

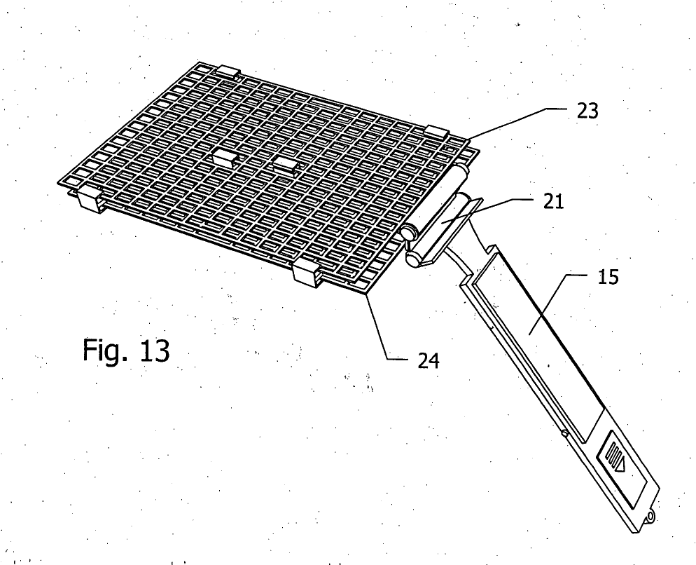

FIG. 13 is a perspective view of an alternate embodiment wherein handle 15 is connected to the parallel meshes (mesh 23 and mesh 24 respectively) by spring-pivot-hinge 21, showing handle bent relative to the parallel meshes.

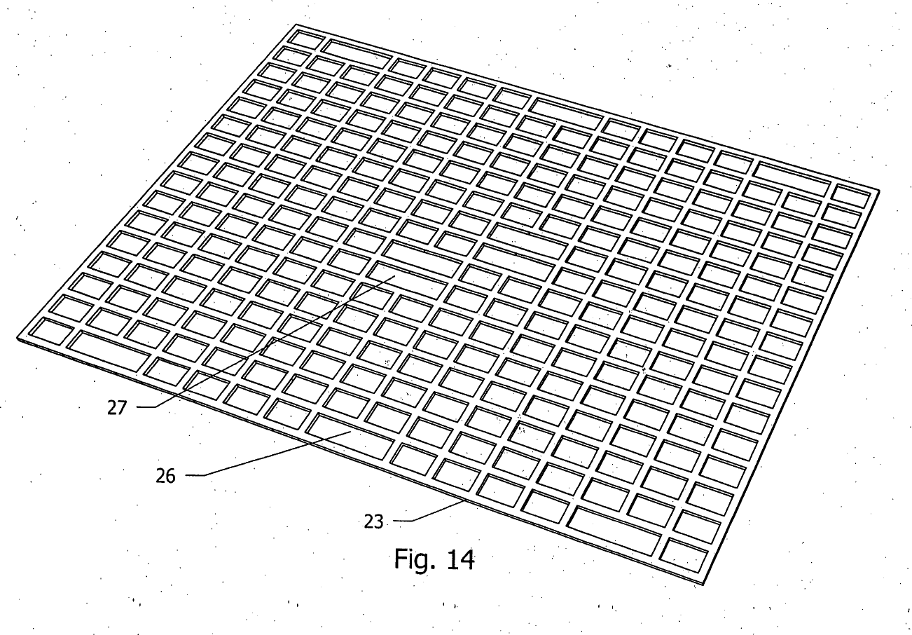

FIG. 14 is a perspective view of a non-deformed mesh 23 (or alternately mesh 24) from the alternate embodiment. It should be noted that the mesh has cut away sections shown as 26 and 27 to allow fastening by the connecting-spacers.

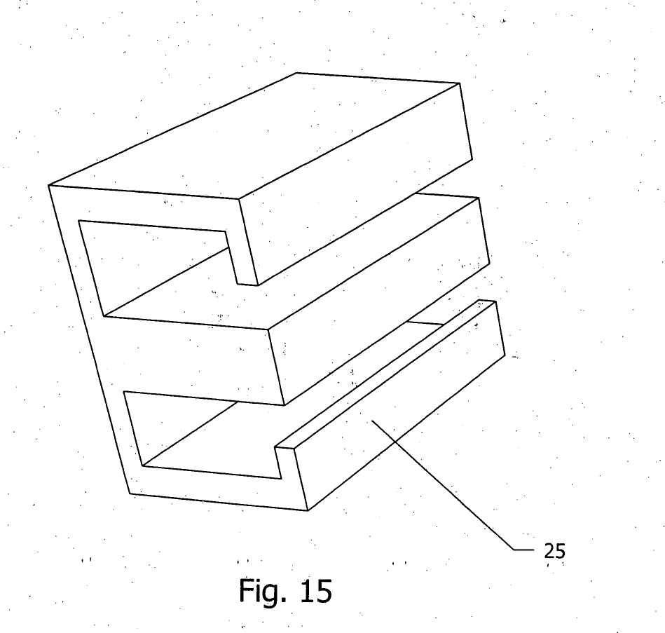

FIG. 15 is an isometric view of a connecting-spacer 25 from the alternate embodiment. Connecting-spacer 25 is comprised of non-electrically conducting shape memory polymer. Connecting-spacer 25 geometry is such that the connecting-spacer distal end grasps top mesh (not shown) while producing a gap in-between the meshes such that the meshes are held in place and not contacting while the proximal end of the connecting-spacer 25 grasps the bottom mesh (not shown).

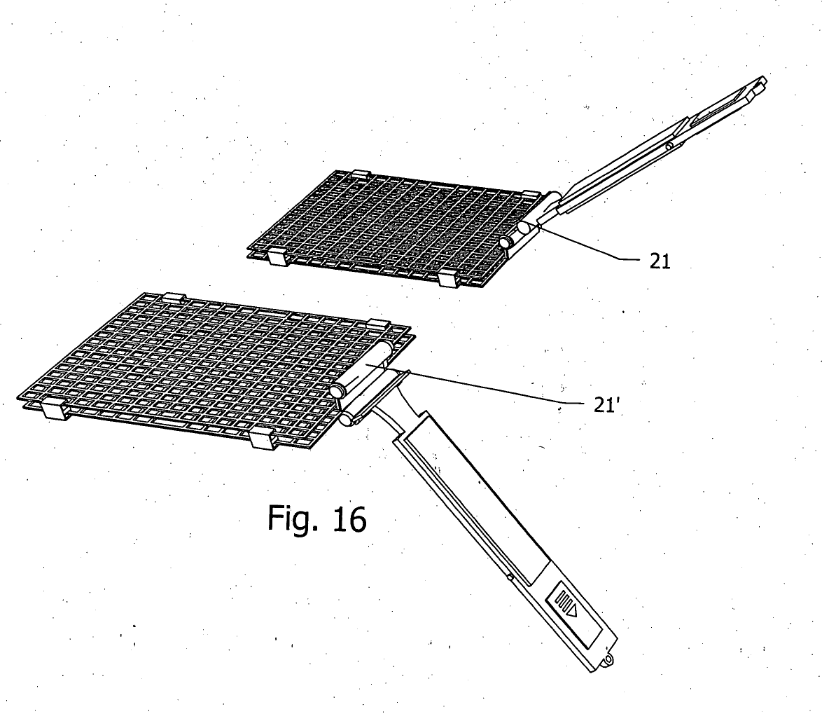

FIG. 16 contains perspective views of spring-pivot-hinge 21 flexed both dorsally and proximately. The spring-pivot-hinge 21 allows the mesh and handle to go from a straight position, to a bent position upon striking a hard surface. Furthermore, the spring-pivot-hinge 21 forces the mesh and handle to return back to a straight position relative to each other after being lifted from a hard surface.

The electric flyswatter's frame 14 with attached handle 15, are made from flexible non-electrically conducting rubber or plastic having shape memory properties. Single layer grid 12 comprising oppositely charged rods 13 are made of electrically conducting shape memory materials. Also the mesh utilized in the alternate embodiment are also made of electrically conducting shape memory materials. The shape memory materials used in the grid, rods, and/or mesh are not limited to electrically conducting shape memory alloys, but they can also be made from electrically conducting shape memory plastics as well. In an alternate embodiment a handle is connected to the frame by a spring-pivot-hinge 21 to allow the frame to bend relative to the handle and return back straight relative to the handle after deflection. Also in an alternate embodiment, a handle is connected to the meshes by a spring-pivot-hinge 21 to allow the meshes to bend relative to the handle and return back straight relative to the handle after deflection. Spring-pivot-hinge 21 is taken to mean any spring-pivot-hinge not just a double spring-pivot-hinge as shown in FIG. 5, FIG. 6 and FIG. 16. FIG. 7, and FIG. 8 demonstrate that spring-pivot-hinge 21 can allow for the handle to bend relative to the frame and spring back to its original position whether being struck proximately or distally on a surface. FIG. 16 demonstrates that spring-pivot-hinge 21 can allow for the handle to bend relative to the meshes and spring back to its original position whether being struck proximately or distally on a surface. Fly 16 is taken to mean any flying or crawling insect, including, flies, mosquitoes, ants, and spiders that are small enough to touch the rods in the first embodiment. Fly 16 is taken to mean any flying or crawling insect, including, flies, mosquitoes, ants, and spiders that are small enough to touch the meshes in the second embodiment. FIG. 3 illustrates a circuit which comprises a high voltage generator utilizing a power source where the high voltage generator comprises of two main parts: an inverter and a voltage multiplier.

It should be noted that grid 12 or alternately rods 13 will rise in temperature due to current flowing in the form of Joule heating (also known as Ohmic heating and resistive heating) when a load is placed in-between the electrically charged grids. The resulting heat caused by the load reforms the shape of the frame and the grid. In the second embodiment of this invention, the meshes also rise in temperature due to current flowing in the form of Joule heating thereby causing a deformed mesh to return back to its original shape after striking a hard surface. Also, shown in FIG. 3, is a discharging element to discharge the current off of the grid 12, or alternately meshes 23 and 24, when not in use so as to prevent small children from getting shocked when sticking their tiny fingers or their tongue in-between the electrified grid or meshes.

It should be noted that the invention can be made of more than one grid. It should be further noted that the invention can be made of more than two meshes It should be also noted, that any invention comprising grids, or alternately rods, or alternately meshes, of electrically conducting shape memory materials would be within the scope of this invention.

While various changes may be made in the detail construction, it is understood that such changes will be within the spirit and scope of the present invention, as is defined by the appended claims.

What is claimed is:

1. A flexible electric flyswatter comprising:
(a) an electrically conducting grid of shape memory materials.

2. A flexible electric flyswatter comprising:
(a) a single layer grid further comprising;
(b) oppositely electrically charged rods of shape memory material;
(c) encased within a flexible frame; and
(4) attached to a handle.

3. The flexible electric flyswatter as recited in claim 2, wherein the flexible frame is comprised of non-electrically conducting shape memory materials.

4. The flexible electric flyswatter as recited in claim 2, wherein the frame is attached to the handle by a swivel-pivot-hinge.

5. The flexible electric flyswatter as recited, in claim 2, wherein a grounding element discharges the electrical charge off the grid.

6. The flexible electric flyswatter as recited in claim 1, wherein two or more of the grids comprise a mesh of electrically conducting shape memory material.

7. A flexible electric flyswatter comprising:
(a) oppositely charged electrically conducting meshes of shape memory materials connected to a handle.

8. The flexible electric flyswatter as recited in claim 7, wherein the meshes are attached to the handle by a spring-pivot-hinge.

9. The flexible electric flyswatter as recited in claim 7, wherein a grounding element discharges the electric charge from the meshes.
